(19) United States
(12) Patent Application Publication
(10) Pub. No.: US 2025/0084329 A1
(43) Pub. Date: Mar. 13, 2025

(54) METHOD FOR IMPROVING FUEL EFFICIENCY

(71) Applicants: VICTOR ALBERTO SPADA TABORGA, CIUDAD DE COCHABAMBA (BO); FRANCISCO XAVIER ITURRALDE TORRICO, CIUDAD DE LA PAZ (BO)

(72) Inventors: VICTOR ALBERTO SPADA TABORGA, CIUDAD DE COCHABAMBA (BO); FRANCISCO XAVIER ITURRALDE TORRICO, CIUDAD DE LA PAZ (BO)

(21) Appl. No.: 18/883,357

(22) Filed: Sep. 12, 2024

(30) Foreign Application Priority Data
Sep. 12, 2023 (EP) 23196716.7

(51) Int. Cl. C10L 1/04

(52) U.S. Cl. CPC C10L 1/04; C10L 2200/0423; C10L 2200/0446; C10L 2290/34

(57) ABSTRACT

A method for improving fuel efficiency by applying a specific resonance frequency to a liquid fuel instead of using chemical additives. The method comprises the following steps: a) introducing a liquid fuel in a fuel tank; b) connecting a frequency generator to the fuel tank by a conductor configured to provide a frequency to the fuel tank; and c) applying a resonance frequency to the liquid fuel during at least one hour, wherein the resonance frequency is between 1.500 to 1.900 Hz.

### CROSS REFERENCE TO RELATED APPLICATION

This application claims the benefit of priority from European Patent Application No. EP 23196716.7, filed Sep. 12, 2023, the contents of which are incorporated herein by reference.

### TECHNICAL FIELD

The present invention relates to the field of energy and fuels. In particular, the present invention relates to a method for improving fuel efficiency by applying a specific resonance frequency to a liquid fuel instead of using chemical additives.

### BACKGROUND OF THE INVENTION

At present, there are several additives that some vehicles use to reduce fuel emissions and thus comply with pollution limits set by regulations in different countries. In addition, these additives improve engine maintenance by removing dirt and obstructions that accumulate in the fuel system and optimize vehicle performance.

However, the use of these additives may involve some dangers, such as interaction with other additives already present in the fuel, as well as incorrect or improper use by users, and high cost.

In recent years, new methods have been developed without the use of chemical additives. These new methods use frequencies to improve fuel efficiency, which also helps to mitigate climate change.

One example is the clean environment-friendly diesel oil preparation method discloses in CN114164027A. This patent document describes a process for preparing a sustainable diesel oil by blending a diesel oil in which a vibrating process at an ultrasonic frequency of 150-180 KHz or between 40-50 kHz, depending on the initial compounds of the blend, is carried out.

The process described in CN114164027A makes it possible to obtain a more environmentally friendly fuel, but it requires many additional compounds and long processes for its transformation, in which the working temperatures and the proportions of each compound in the mixture must be very carefully controlled.

US2005051144A1 discloses an electronic device used to emit a complex magnetic field for improve the combustion efficiency of hydrocarbon-based fuel systems and decreases their harmful emissions by treating the fuel at the entry point of the engine or combustion device. The device discloses a fast rise time pulse with a frequency sweep between 3.000 and 7.000 Hz. The method of this invention consists of applying frequency changes to the fuel through a coil to atomise the fuel and improve combustion. The use of a coil and a closed circuit requires high energy consumption and strict control of the application of the frequency changes to ensure its success.

Therefore, although these methods are emerging as an alternative to traditional methods using additives, there is a need for new methods that are environmentally friendly, simple and do not require high energy consumption.

### SUMMARY OF THE INVENTION

The inventors of the present invention, after extensive and exhaustive research, have surprisingly found a method for improving fuels without using chemical additives, which is environmentally friendly, simple and does not require high energy consumption.

The method of the present invention helps to reduce environmental pollution by the effect of the emission of polluting gases, which represent a serious threat to the environment and the health of people.

The method of the present invention is based on applying a specific resonance frequency to liquid fuel (gasoline and diesel) for its improvement and enhancement. This vibration or resonance can be induced artificially by subjecting the liquid combustible substance to an electric potential of specific frequency using a frequency generator.

The fuels treated by the method of the present invention are transformed into improved fuels without the use of chemical additives and achieve in internal combustion engines that they reach a perfect combustion preventing them from accumulating harmful materials product of incomplete combustion (carbon).

The method of the present invention provides a liquid fuel with a higher density and viscosity, which generates a greater amount of mass per unit volume, which is converted into greater energy production when used in vehicles or machines, allowing a 20% increase in performance in kilometres per litre in vehicles; on the other hand, it reduces pollution and exhaust gas emissions.

Therefore, the present invention solves the technical problems present in the state of the art and mentioned above.

In a first aspect, the present invention refers to a method for improving fuel efficiency characterized by the following steps:
a) introducing a liquid fuel in a fuel tank;
b) connecting a frequency generator to the fuel tank by means of a conductor configured to provide a frequency to the fuel tank; and
c) applying a resonance frequency to the liquid fuel during at least one hour, wherein the resonance frequency is between 1.500 to 1.900 Hz.

Preferably, in the method of the present invention the liquid fuel is selected from the group consisting of gasoline and diesel.

In an embodiment of the method of the present invention, the resonance is applied during one to three hours. Preferably, between one hour and two hours. A period of at least one hour guarantees a change in the molecular structure of the fuel. If a longer time is used, such as two hours or even three hours, a slightly greater improvement is achieved. However, no significant modification is achieved with times longer than 3 hours.

In another embodiment of the method of the present invention, the resonance frequency is between 1.600 to 1.750 Hz.

In another embodiment of the method of the present invention, the conductor is in the form of electrodes or metal plates. The metal plates are made of metals with high thermal conductivity, such as steel plates, aluminium plates and/or copper plates.

In a preferred embodiment of the method of the present invention, the conductor is in the form of electrodes located in an external wall of the tank.

In another preferred embodiment, the conductor is in the form of metal plates located inside the tank or in an external wall of the tank.

In a second aspect, the present invention refers to a fuel obtained by the method as described above.

### DETAILED DESCRIPTION OF THE INVENTION

### Example 1. Method for Improving Diesel Fuel Efficiency of the Present Invention and Results for Pour Point, Cetane Index, Calorific Value and Total Sulphur

10 liters of diesel fuel were introduced in a fuel tank. A frequency generator was connected to the fuel thank by means of two electrodes. These electrodes were introduced in the fuel tank. A resonance frequency between 1.600 to 1.750 Hz was applied to the diesel fuel during at least one hour. The fuel obtained was compared with two samples of commercial diesel fuel.

Table 1 shows the values obtained from the pour point, cetane index, calorific value, and total sulphur for two samples of commercial diesel fuel (samples 1 and 2) and a sample of diesel fuel treated by the method of the present invention (treated sample).

TABLE 1
Values obtained for the pour point, cetane index, calorific
value and total sulphur of the samples analyzed.

| | Measurement | | | Treated |
|---|---|---|---|---|
| Test | method used | Sample 1 | Sample 2 | sample |
| Pour point (° C.) | ASTM D97 | −1.1 | −1.1 | −6 |
| Cetane index | ASTM D976 | 45 | 45 | 55.4 |
| Calorific value | ASTM D240 | — | — | 20.001 |
| (Btu/lb) | | | | |
| Total sulphur | ASTM D1266 | 0.5 | 0.5 | 0.019 |
| (wt %) | | | | |

In the values obtained (see Table 1), the sample treated with the method of the present invention presents an increase in the Cetane index of 10 points and an increase in the calorific value from 192 00 Btu/lb to 20 001 Btu/lb, which indicates that it delivers more energy during the burning of the fuel thus increasing the fuel efficiency in kilometers per liter.

The treated sample also presents a reduction in the percentage of sulphur falling from 0.5% to 0.019% by weight, which ensures a better lubricity in the equipment and less wear of parts due to corrosion, such as fuel pump, filters, injectors, rings among others.

The reduction in sulphur content also means less pollution of the atmosphere by exhaust gases from vehicles and industrial plants; fuels with a high sulphur content release sulphur oxide (SOx), which are precursors to acid rain and other greenhouse gases.

The improvement in combustion allows to obtain up to 25% increase in power, an increase in performance in kilometers per liter of 20% and a substantial decrease in the emission of polluting gases and avoiding the noise (known as rattle or piston) that occurs when using low-octane gasoline.

There is also an improvement in the pour point from −1° C. to −6° C., which is very useful for use in mining centers at high altitudes and low ambient temperatures.

### Example 2. Method for Improving Commercial Gasoline Efficiency of the Present Invention and Results of Dynamometer, Density, and Viscosity Tests

10 liters of commercial gasoline were introduced in a fuel tank. A frequency generator was connected to the fuel thank by means of two electrodes. These electrodes were introduced in the fuel tank. A resonance frequency between 1.600 to 1.750 Hz was applied to the gasoline during one hour. The gasoline obtained was compared with one sample of commercial gasoline.

Table 2 shows the values obtained in a dynamometer study measuring the power in wheels and torque using one sample of commercial gasoline (sample 1) and a gasoline treated by the method of the present invention (treated sample).

TABLE 2
Values obtained from the dynamometer
test of the samples analyzed.

| | | | | Increase |
|---|---|---|---|---|
| Test | No. | Sample 1 | Treated sample | (%) |
| Torque [N-m] | 1 | 101.90 | 118.90 | 16.68 |
| | 2 | 113.40 | 118.60 | 4.59 |
| | 3 | 116.80 | 119.00 | 1.88 |
| | Average | 110.70 | 118.80 | 7.32 |
| Wheel power (kw) | 1 | 12.00 | 22.20 | 85.00 |
| | 2 | 14.80 | 22.60 | 52.70 |
| | 3 | 17.10 | 22.80 | 33.33 |
| | Average | 14.60 | 22.50 | 54.11 |

The values obtained show an average increase of 7.32% in torque and 54.11% in power at the wheels in the dynamometer tests carried out with the gasoline treated by the method of the present invention.

The change in density and viscosity of the fuel was also tested. Table 3 shows the density measurement by gravimetry using a pycnometer with a volumetric capacity of 25 ml, both for the treated sample and the sample 1.

TABLE 3
Density values obtained by gravimetry of both samples.

| | Vacuum | Full | |
|---|---|---|---|
| | Pycnometer | pycnometer | Period (g) |
| Treated | 32.54 | 51.89 | 19.35 |
| Sample | 32.55 | 51.88 | 19.84 |
| | 32.56 | 51.97 | 19.83 |

| | |
|---|---|
| Average Mass (g) | 19.84 |
| Volume (ml) | 25 |
| Density (g/ml) | 0.7936 |

| | | | |
|---|---|---|---|
| Sample | 33.44 | 52.34 | 18.90 |
| 1 | 33.45 | 52.33 | 18.89 |
| | 33.46 | 52.32 | 18.88 |

| | |
|---|---|
| Average Mass (g) | 18.89 |
| Volume (ml) | 25 |
| Density (g/ml) | 0.7556 |

The results show that gasoline treated with the method modifies its density by increasing it, which indicates that there is more mass in a certain volume after treatment and this affects performance and combustion since a denser gasoline contains more energy per unit volume and therefore generates more energy.

Table 4 shows the comparison of the measurement of the viscosity using a Brookfield viscometer.

TABLE 4
Comparison of the viscosity of the two samples.

| | Sample 1 | Treated sample |
|---|---|---|
| Viscometer constant at | 3.82674 × 10⁻⁷ | 3.49487 × 10⁻⁷ |
| 40° C. | m²/s² | m²/s² |
| Viscosity (Pa · s) | 6.94 × 10⁻⁴ | 7.70 × 10⁻⁴ |

The values obtained show an increase in the viscosity of the fuel treated with the method, the value obtained is within normal parameters but corresponds to a fuel of better quality and higher octane. Density and viscosity are variables directly related to fuel quality, and higher viscosity indicates that it contains more energy per unit volume.

1. A method for improving fuel efficiency comprising the following steps:
a) introducing a liquid fuel in a fuel tank;
b) connecting a frequency generator to the fuel tank by means of a conductor configured to provide a frequency to the fuel tank; and
c) applying a resonance frequency to the liquid fuel during at least one hour, wherein the resonance frequency is between 1.500 to 1.900 Hz.

2. The method according to claim 1, wherein the resonance frequency is between 1.600 to 1.750 Hz.

3. The method according to claim 1, wherein the resonance is applied during one hour to three hours.

4. The method according to claim 1, wherein the liquid fuel is selected from the group consisting of gasoline and diesel.

5. The method according to claim 1, wherein the conductor is in the form of electrodes or metal plates.

6. The method according to claim 5, wherein the conductor is in the form of electrodes located in an external wall of the tank.

7. The method according to claim 5, wherein the conductor is in the form of metal plates located inside the tank or in an external wall of the tank.

8. A fuel obtained by the method according to claim 1.
